(19) United States
(12) Patent Application Publication
(10) Pub. No.: US 2024/0240513 A1
(43) Pub. Date: Jul. 18, 2024

(54) Deployable Blocking Device

(71) Applicant: Heather Ross, Castle Rock, CO (US)

(72) Inventor: Heather Ross, Castle Rock, CO (US)

(21) Appl. No.: 18/098,096

(22) Filed: Jan. 17, 2023

(51) Int. Cl. E06B 7/36

(52) U.S. Cl. CPC E06B 7/367; E06B 9/24

(57) ABSTRACT

Disclosed is a portable blocking device for increasing privacy in a public restroom stall or similar public place and includes a retractable fabric for covering an opening, gap, or aperture in the construct of the restroom stall or similar public place. The deployable blocking device has a member that can be extended downward from a retracted position to an extended position covering the opening, gap, or aperture, thereby preventing anyone located exterior of the restroom stall or other similar public place from seeing into the interior through such opening, gap, or aperture. At the conclusion of its use when the individual is ready to exit the restroom stall or other similar public place, the deployable blocking device can be retracted and removed from the top portion of the stall door and stall door jamb and placed in a purse or pocket of the individual.

### FIELD OF THE INVENTION

This disclosure relates generally to the field of blocking devices, and more specifically to the field of deployable blocking devices.

### BACKGROUND OF THE INVENTION

Obtaining privacy in public places, such as fitting rooms, changing rooms, public restrooms, locker rooms, showers, and other such places is often a problem. For example, restroom stalls typically have metal or wood panels or partitions that form a somewhat enclosed private area. A door for entrance and regress rotates between an open and a closed position. However, there typically is a space or gap between the hinge side of the stall door and the stall door jamb, and a space or gap between the non-hinged side of the stall door and the stall door jamb, that allows a person on the outside of the restroom stall to see through the gap and invade the privacy of the person inside the restroom stall. Many individuals are very uncomfortable and embarrassed to been seen by strangers who peer through the gap at them.

What is needed is a deployable blocking device that increases and maximizes an individual's privacy within a public place such as a restroom stall. More specifically, what is needed is a portable deployable blocking device that obstructs the view between the interior and exterior of a restroom stall due to any gaps and/or apertures within the stall's constructs. Additionally, what is needed is a portable deployable blocking device that easily and quickly allows an individual in a restroom stall to maximize his or her privacy therein by eliminating the ability of others exterior to the restroom stall to view the stall's interior through any gaps and/or apertures.

A portable retractable device, having embodiments disclosed herein, meets the needs described in the above paragraph while also providing several advantages. Each embodiment of the deployable blocking device provides for simple and easy packaging, storage, affordability, ease of use, transportability, and the like. As such, the deployable blocking device can be placed in a purse or pocket until needed.

### SUMMARY OF THE INVENTION

In one embodiment, once an individual desires increased privacy in a public place, such as a restroom stall or other similar public place because of gap(s) and/or aperture(s) due to the stall's constructs, a deployable blocking device can be affixed to the top portion of the stall door and stall door jamb having an opening, gap, or aperture. The deployable blocking device has a member that can be extended downward from a retracted position to an extended position covering the opening, gap, or aperture, thereby preventing anyone located exterior of the restroom stall or other similar public place from seeing into the interior through such opening, gap, or aperture. At the conclusion of its use—presumably at the time when the individual is ready to exit the restroom stall or other similar public place, the deployable blocking device can be retracted and removed from the top portion of the stall door and stall door jamb and placed in a purse or pocket of the individual.

### BRIEF DESCRIPTION OF THE DRAWINGS

FIG. 1 shows the deployable blocking device in a retracted position attached to the gap between a stall door and the stall door jamb in a closed position where the stall door jamb extends higher than the top of the door in an embodiment of the deployable blocking device.

FIG. 2 shows the deployable blocking device in a retracted position attached to the gap between a stall door and the stall door jamb in a closed position where the stall door jamb and the top of the door are the same height in an embodiment of the deployable blocking device.

FIG. 3 shows the deployable blocking device in an extended position from the retracted position as shown in either FIG. 1 or 2 in the inside of a restroom stall in an embodiment of the deployable blocking device.

FIG. 4 shows the top end of the foldable fabric affixed to the back side of the retraction device and the retraction device is fixedly attached to the outside of one of the two buttons in an embodiment of the deployable blocking device.

FIG. 5 is the reverse view of FIG. 4 showing the front side of the retraction device which is attached to the outside of one of the two buttons in an embodiment of the deployable blocking device.

FIG. 6 shows a front view of one of the buttons with the two elastic ties extending from two holes in the button in an embodiment of the deployable blocking device.

FIG. 7 shows a top view of both buttons showing the two elastic ties extend through the two holes in each button, and how the two elastic ties connect to each other on the outsides of the two buttons in an embodiment of the deployable blocking device.

FIG. 8 shows a sticky spot of glue that helps hold the deployable blocking device in place between the stall door and the stall jamb in an embodiment of the deployable blocking device.

FIG. 9 shows a strip of rubber that helps hold the deployable blocking device in place between the stall door and the stall jamb in an embodiment of the deployable blocking device.

FIG. 10 shows a flow chart in an embodiment of using the deployable blocking device.

To assist in the understanding of the present disclosure the following list of components and associated numbering found in the drawings is provided herein:

Table of Components.

| Component | # |
|---|---|
| button | 1 |
| button | 2 |
| elastic tie | 3 |
| big loop end | 3a |
| small loop end | 3b |
| elastic tie | 4 |
| big loop end | 4a |
| small loop end | 4b |
| hole | 5a |
| hole | 6a |
| Hole | 5b |
| hole | 6b |
| gap | 7 |
| stall door | 8 |
| stall door jamb | 9 |
| retraction device | 10 |
| fabric | 11 |
| tab | 12 |
| release button | 13 |
| strip | 14 |
| holes | 15 |
| glue strip | 16 |
| spot of glue | 17 |
| rubber strip | 18 |
| deployable blocking device | 100 |
| method | 1000 |

### DETAILED DESCRIPTION

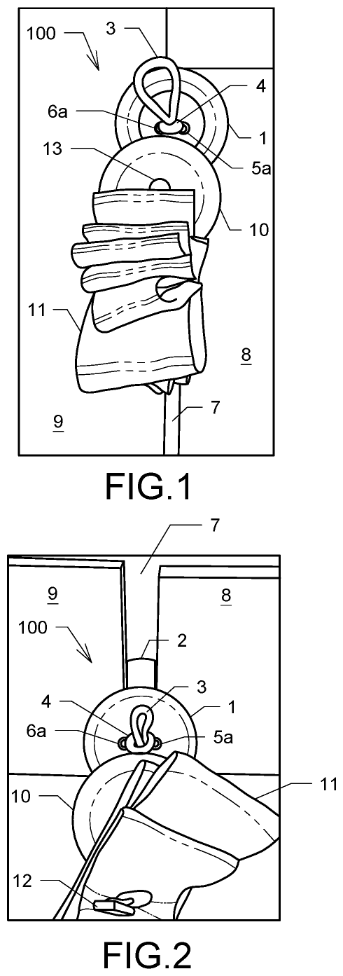

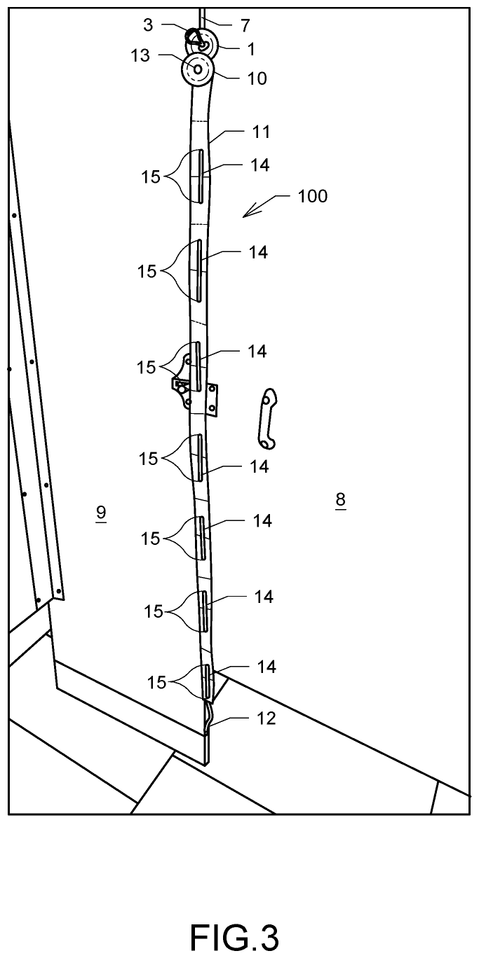

FIG. 1 shows the deployable blocking device in a retracted position attached to the gap between a stall door and the stall door jamb in a closed position where the stall door jamb extends higher than the top of the door in an embodiment of the deployable blocking device. FIG. 2 shows the deployable blocking device in a retracted position attached to the gap between a stall door and the stall door jamb in a closed position where the stall door jamb and the top of the door are the same height in an embodiment of the deployable blocking device. Referring now to FIGS. 1 and 2, deployable blocking device 100 has button 1 elastically connected to button 2 by way of elastic tie 3 and elastic tie 4. In one embodiment, button 1 and button 2 are about two inches in diameter, but other sized buttons may also be used as long as the diameter of button 1 and button 2 is greater than a gap 7 between a stall door 8 and a stall door jamb 9. Button 1 has at least two holes, holes 5a and 6a. Button 2 has at least two holes, holes 5b and 6b. Elastic tie 3 and elastic tie 4 are threaded through holes 5a and 6a of button 1 and holes 5b and 6b of button 2 (see FIG. 7) to provide resistance against the stall door 8 and stall door jamb 9. The user can adjust the tension by pulling on elastic tie 3 and elastic tie 4 that extend outward from button 1 and button 2. Retraction device 10 is fixedly attached to a lower outside portion of button 1, typically through gluing, or any other suitable method. Retraction device 10 has a first end of fabric 11 attached thereto. Fabric 11 is shown in the retracted position in FIGS. 1 and 2. Tab 12 is pulled to extend fabric 11 (see FIG. 3) in the extended position. Release button 13 is pressed to retract fabric 11 to the retracted position.

FIG. 3 shows the deployable blocking device in an extended position from the retracted position as shown in either FIG. 1 or 2 in the inside of a restroom stall in an embodiment of the deployable blocking device. A single commode public restroom with a traditional locking door in a door frame provides privacy and seclusion from the public. If a public restroom supports the use of several individuals at one time (i.e., by having two or more commodes) it is generally partitioned so that privacy is maintained for each of the two or more commodes. These partitions, referred to as stalls, are usually constructed around each commode within the restroom, thereby providing each individual who is utilizing a commode with a measure of privacy. Generally, each stall will have several sides (i.e., stall walls) and a stall door. Inside the restroom stall is a commode. Once an individual enters a stall, the individual typically closes and locks the door for maximum privacy.

Referring now to FIG. 3, stall door 8 and stall door jamb 9 are shown with deployable blocking device 100 in the extended position. Button 1 is shown and button 2 is on the other side of stall door 8 and stall door jamb 9 and is not visible. Elastic tie 3 and elastic tie 4 are pulled apart from each other to apply tension between button 1 and button 2 that grip stall door 8 and stall door jamb 9. Fabric 11 is a flexible non-transparent material that in one embodiment is about 2 inches wide by about 4 feet long. Other widths and lengths can be used to accommodate different sizes of gap 7 and stall door 8 lengths. Strip 14 is continuous and is capable of being rolled up inside retraction device 10 via a spring or other mechanism and extend out from retraction device 10. One end of strip 14 is attached internally inside retraction device 10 and the other end of strip 14 has tab 12 attached thereto. Tab 12 prevents strip 14 from passing through hole 15 at the bottom of fabric 11. Strip 14 is very flexible and intertwines in-and-out through fabric 11 through a series of holes 15 from top to bottom. In one embodiment, strip 14 is about ¼ inch wide, but other widths and even a string could be used. Tab 12 is pulled causing the strip 14 to unroll from retraction device 10 and allowing fabric 11 to unfold from the retracted position to the extended position shown. Ceasing pulling tab 12 causes strip 14 to automatically lock in place. Release button 13 is pressed and held to retract strip 14 inside retraction device 10, causing fabric 11 to fold over onto itself as shown in FIGS. 1 and 2. In the extended position, fabric 11 covers the gap 7 between stall door 8 and stall door jamb 9 providing privacy for the individual using the commode.

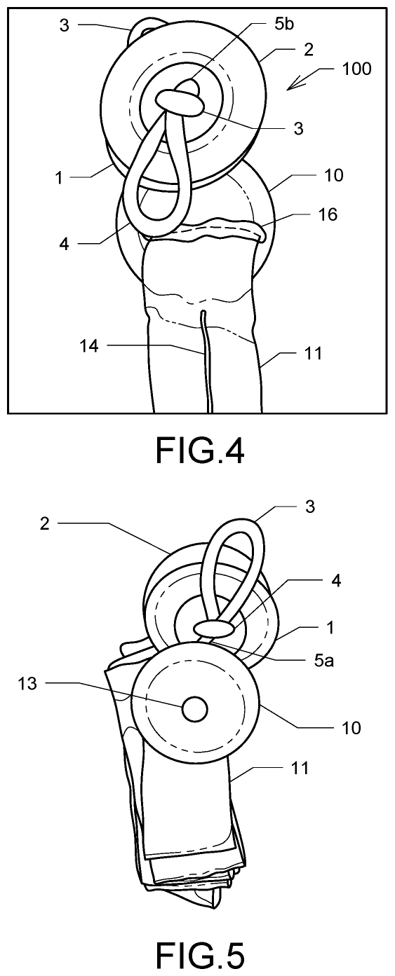

FIG. 4 shows the top end of the foldable fabric affixed to the back side of the retraction device and the retraction device is fixedly attached to the outside of one of the two buttons in an embodiment of the deployable blocking device. Referring now to FIG. 4, deployable blocking device 100 is shown reversed from FIGS. 1 and 2. Button 2 can now be seen with button 1 behind it mostly hidden. Elastic tie 3 and elastic tie 4 are shown. Fabric 11 is fixedly attached to the back side of retraction device 10 typically through a glue strip 16 or any other suitable attachment device to affix the end of the fabric 11 to the retraction device 10.

FIG. 5 is the reverse view of FIG. 4 showing the front side of the retraction device which is attached to the outside of one of the two buttons in an embodiment of the deployable blocking device. Referring now to FIG. 5, button 1 is in front of button 2 with elastic tie 3 and elastic tie 4 visible. Fabric 11 is shown in the retracted position from retraction device 10.

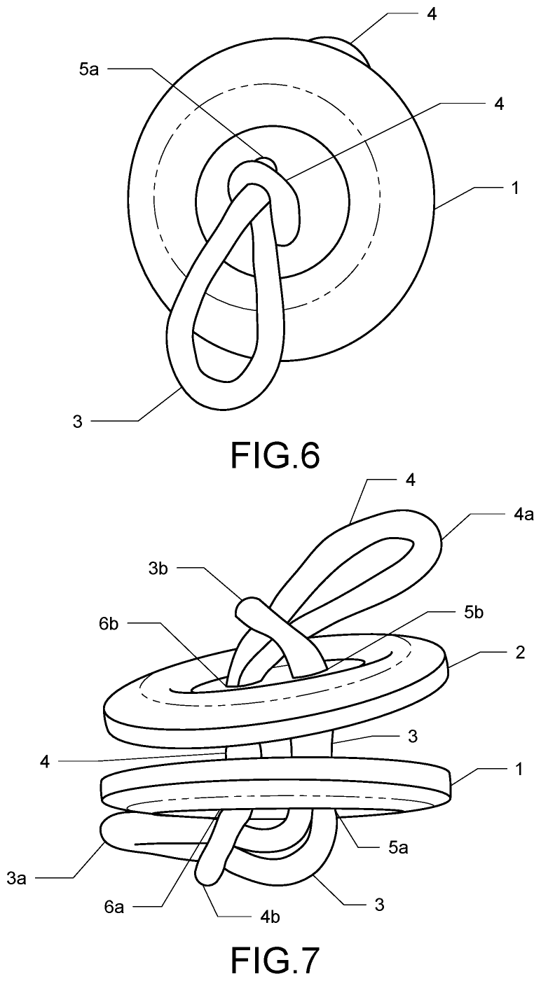

FIG. 6 shows a front view of one of the buttons with the two elastic ties extending from two holes in the button in an embodiment of the deployable blocking device. Referring now to FIG. 6, retraction device 10 is not shown for clarity. Button 1 has elastic tie 3 extending from hole 5a and elastic tie 4 extends from hole 6a (not visible in FIG. 6). The other end of elastic tie 4 is seen behind button 1. Button 2 is directly behind button 1 and is not visible in FIG. 6.

FIG. 7 shows a top view of both buttons showing the two elastic ties extend through the two holes in each button, and how the two elastic ties connect to each other on the outsides of the two buttons in an embodiment of the deployable blocking device. Referring now to FIG. 7, retraction device 10 is not shown for clarity. Elastic tie 3 has a big loop end 3a extending from button 1 and passes through hole 5a and out of hole 5b of button 2 to form a small loop end 3b extending from button 2 that is looped over elastic tie 4. Likewise, elastic tie 4 has a big loop end 4a extending from button 2 and passes through hole 6b and out of hole 6a to form a small loop end 4b extending from button 1 that is looped over elastic tie 3. Once button 1 and button 2 are placed over the gap 7 of stall door 8 and stall door jamb 9, pulling on big loop end 3a and/or big loop end 4a will cause button 1 and button 2 to be drawn toward each other applying tension to stall door 8 and stall door jamb 9 and thus securing themselves to stall door 8 and stall door jamb 9. The elastic nature of elastic tie 3 and elastic tie 4 allows button 1 and button 2 to be placed on stall door 8 and stall door jamb 9 of varying widths.

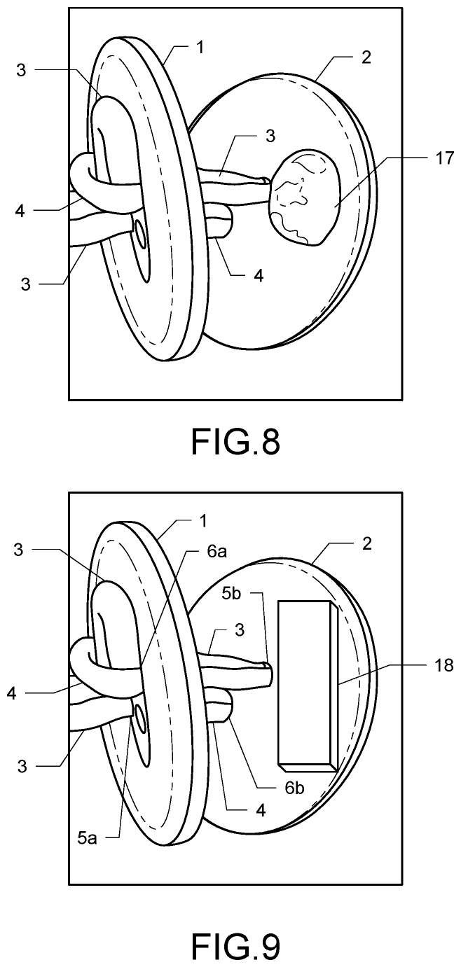

FIG. 8 shows a sticky spot of glue that helps hold the deployable blocking device in place between the stall door and the stall jamb in an embodiment of the deployable blocking device. FIG. 9 shows a strip of rubber that helps hold the deployable blocking device in place between the stall door and the stall jamb in an embodiment of the deployable blocking device. Referring now to FIGS. 8 and 9, button 1 may optionally have a spot of glue 17 or a rubber strip 18, or button 2 may have a spot of glue 17 or a rubber strip 18, or both button 1 and button 2 may have a spot of glue 17 or a rubber strip 18 to provide enhanced friction to stall door 8 and stall door jamb 9. Spot of glue 17 and rubber strip 18 are fixedly attached to the insides of button 1 and/or button 2. Spot of glue 17 and rubber strip 18 enhance the tension action provided by elastic tie 3 and elastic tie 4.

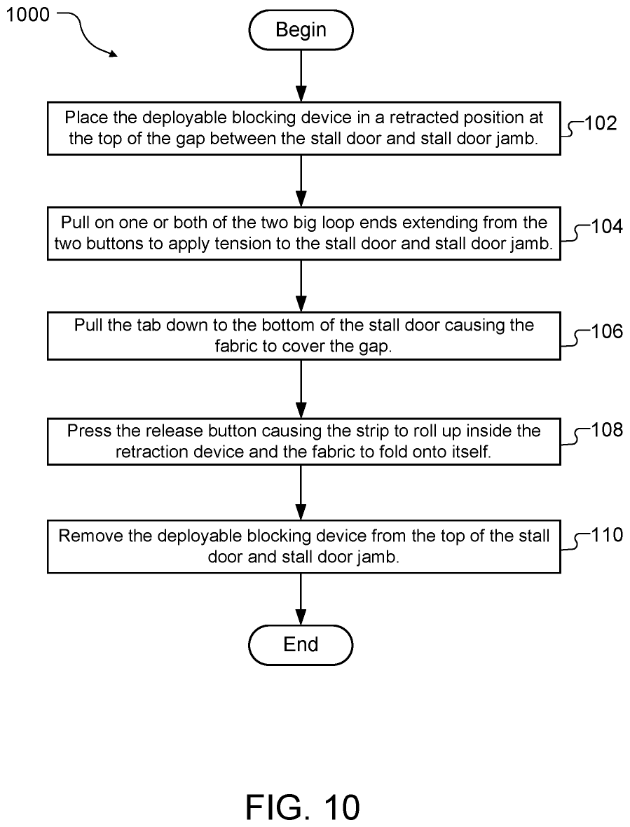

FIG. 10 shows a flow chart in an embodiment of using the deployable blocking device. Referring now to FIG. 10, the method 1000 begins in step 102 with deployable blocking device 100 in a retracted position. Button 1 and button 2 are pulled apart a bit to allow the deployable blocking device 100 to be placed at the top of the gap 7 between the stall door 8 and the stall door jamb 9.

In step 104 big loop end 3a and/or big loop end 4a are pulled outwardly from button 1 and button 2 respectively causing button 1 and button 2 to be drawn toward each other, applying tension to stall door 8 and stall door jamb 9 and thus securing deployable blocking device 100 to stall door 8 and stall door jamb 9. Optionally, if deployable blocking device 100 has glue spot 17 or rubber strip 18, tension to stall door 8 and stall door jamb 9 is enhanced.

In step 106 tab 12 is pulled down towards the bottom of the gap 7 causing fabric 11 to cover the gap 7 from the top of the stall door 8 to the bottom of the stall door 8.

In step 108 the release button 13 is pressed causing the strip 14 to roll up inside the retraction device 10 which causes the fabric 11 to fold up upon itself returning the deployable blocking device 100 into the retracted position.

In step 110 the deployable blocking device 100 is removed from the top of the stall door 8 and stall door jamb 9 and the method ends.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

Having described the present invention, it will be understood by those skilled in the art that many changes in construction and widely differing embodiments and applications of the invention will suggest themselves without departing from the scope of the present invention.

What is claimed is:

1. A method for using a deployable blocking device, the method comprising the steps of:
(a) positioning the deployable blocking device over a gap between a first wall member and a second wall member wherein the deployable blocking device is in a retracted position; and
(b) pulling a tab of a retraction device of the deployable blocking device down to a bottom of the first wall member causing a fabric of the retraction device to cover the gap between the first wall member and the second wall member, thereby placing the deployable blocking device in an extended position.

2. The method for using a deployable blocking device according to claim 1 further comprising the step of:
pulling on at least one of:
a big loop end of a first elastic tie that extends from a first button of the deployable blocking; and
a big loop end of a second elastic tie that extends from a second button of the deployable blocking thereby applying a tension between the first button and the second button causing the first button and the second button to grip the first wall member and the second wall member.

3. The method for using a deployable blocking device according to claim 1 further comprising the step of:
pressing a release button of the retraction device causing the fabric to fold onto itself to return to the retracted position.

4. The method for using a deployable blocking device according to claim 3 further comprising the step of:
removing the deployable blocking device from the first wall member and the second wall member.

5. A deployable blocking device comprising:
a first button;
a second button;
a first elastic tie that connects the first button to the second button;
a second elastic tie that connects the first button to the second button;
a retraction device attached to at least one of the first button and the second button, the retraction device further comprising:
a fabric attached at a first end to the retraction device;
a strip having a first end that is attached internally in the retraction device;
a second end of the strip that extends to a second end of the fabric;
a tab attached to the second end of the strip, wherein pulling the tab puts the deployable blocking device into an extended position; and
a release button that is pressed and held to cause the strip to retract inside the retraction device and cause the fabric to fold onto itself and puts the deployable blocking device into a retracted position.

6. The deployable blocking device according to claim 5 further comprising:
a plurality of holes spaced along a length of the fabric wherein the strip intertwines in-and-out through the plurality of holes in fabric and the second end of the strip extends through a last of the plurality of holes at the second end of the fabric wherein the tab prevents the strip from passing back through the last of the plurality of holes.

7. The deployable blocking device according to claim 5 further comprising:
at least a first hole and a second hole in the first button; and
at least a first hole and a second hole in the second button;
wherein the first elastic tie extends through the at least first hole of the first button and through the at least first hole of the second button and the second elastic tie extends through the at least second hole of the first button and through the at least second hole of the second button.

8. The deployable blocking device according to claim 7 wherein the first elastic tie further comprises:
a big loop end that extends through the at least first hole of the first button;
a small loop end that extends through the at least first hole of the second button; and
wherein the second elastic tie further comprises:
a big loop end that extends through the at least second hole of the second button; and
a small loop end that extends through the at least second hole of the first button.

9. The deployable blocking device according to claim 8 wherein the small loop end is looped over the big loop end and the small loop end is looped over the big loop end.

10. The deployable blocking device according to claim 5 further comprising:
an attachment device for fixedly attaching the first end of the fabric to the retraction device.

11. The deployable blocking device according to claim 5 further comprising:
a spot of glue on an inner surface of at least one of the first button and the second button to provide enhanced friction.

12. The deployable blocking device according to claim 5 further comprising:
a rubber strip on an inner surface of at least one of the first button and the second button to provide enhanced friction.

13. A deployable blocking device comprising:
a first button having at least a first hole and a second hole;
a second button having at least a first hole and a second hole;
a first elastic tie that extends through the at least first hole of the first button and through the at least first hole of the second button;
a second elastic tie that extends through the at least second hole of the first button and through the at least second hole of the second button; and
a retraction device attached to at least one of the first button and the second button, the retraction device further comprising:
a fabric attached at a first end to an exterior surface of the retraction device;
a plurality of holes spaced along a length of the fabric;
a strip having a first end that is attached internally in the retraction device and the strip intertwines in-and-out through the plurality of holes in fabric;
a second end of the strip that extends through a last of the plurality of holes at a second end of the fabric;
a tab attached to the second end of the strip, wherein the tab prevents the strip from passing back through the last of the plurality of holes wherein pulling the tab puts the deployable blocking device into an extended position; and
a release button that is pressed and held to cause the strip to retract inside the retraction device and cause the fabric to fold onto itself and puts the deployable blocking device into a retracted position.

14. The deployable blocking device according to claim 13 wherein the first elastic tie further comprises:
a big loop end that extends through the at least first hole of the first button; and
a small loop end that extends through the at least first hole of the second button.

15. The deployable blocking device according to claim 14 wherein the second elastic tie further comprises:
a big loop end that extends through the at least second hole of the second button; and
a small loop end that extends through the at least second hole of the first button.

16. The deployable blocking device according to claim 15 wherein the small loop end is looped over the big loop end.

17. The deployable blocking device according to claim 15 wherein the small loop end is looped over the big loop end.

18. The deployable blocking device according to claim 13 further comprising:
an attachment device for fixedly attaching the first end of the fabric to the retraction device.

19. The deployable blocking device according to claim 13 further comprising:
a spot of glue on an inner surface of at least one of the first button and the second button to provide enhanced friction.

20. The deployable blocking device according to claim 13 further comprising:
a rubber strip on an inner surface of at least one of the first button and the second button to provide enhanced friction.
